(19) United States
(12) Patent Application Publication
(10) Pub. No.: US 2013/0070781 A1
(43) Pub. Date: Mar. 21, 2013

(54) PROBABILISTIC CONTENTION WINDOW MANAGEMENT

(71) Applicants: Ramanuja VEDANTHAM, Allen, TX (US); Kumaran VIJAYASANKAR, Dallas, TX (US); Tarkesh PANDE, Dallas, TX (US); Anand DABAK, Plano, TX (US)

(72) Inventors: Ramanuja VEDANTHAM, Allen, TX (US); Kumaran VIJAYASANKAR, Dallas, TX (US); Tarkesh PANDE, Dallas, TX (US); Anand DABAK, Plano, TX (US)

(73) Assignee: TEXAS INSTRUMENTS INCORPORATED, Dallas, TX (US)

(21) Appl. No.: 13/609,885

(22) Filed: Sep. 11, 2012

Related U.S. Application Data
(60) Provisional application No. 61/535,637, filed on Sep. 16, 2011.
(60) Provisional application No. 61/535,663, filed on Sep. 16, 2011.

(51) Int. Cl. H04L 12/413

(52) U.S. Cl. 370/447

(57) ABSTRACT

Method and apparatus for communicating via a network. In one embodiment, a device for communicating via a network includes a medium access controller (MAC). The MAC is configured to apply a contention window for collision avoidance on the network, and to determine whether the network is free for use on expiration of a time value of the contention window. The MAC is also configured to initiate a transmission based on a determination that the network is free for use. The MAC is further configured to increase, in accordance with a predetermined probability value, the time value of the contention window based on: the transmission being successful; and the time value of the contention window being a minimum contention window time value. The probability value establishes the likelihood of the MAC increasing the time value of the contention window with respect to successful transmissions with the minimum contention window time value.

### CROSS-REFERENCE TO RELATED APPLICATION

The present application claims priority to U.S. Provisional Patent Application Nos. 61/535,637, filed on Sep. 16, 2011 (Attorney Docket No. TI-71476) and 61/535,663, filed on Sep. 16, 2011 (Attorney Docket No. TI-71477); which are hereby incorporated herein by reference in their entirety.

### BACKGROUND

Communication networks employ various techniques to avoid or reduce the number of collisions occurring when different devices transmit concurrently. Carrier sense multiple access (CSMA) methods require that each device check the communication medium for traffic prior to initiating a transmission. CSMA with collision detection (CD) is employed in some networks (e.g., Ethernet) that are amenable to detection of simultaneous transmission by different devices. Using CSMA/CD, network devices monitor the medium for collisions while transmitting, and retransmit if a collision is detected. CSMA with collision avoidance (CA) is applied in some networks in which collision detection is impractical (e.g., networks compliant with IEEE 802.11 standards). Using CSMA/CA, network devices attempt to reduce the number of collisions by randomizing transmission start time relative to a previous transmission.

### SUMMARY

A method and apparatus for communicating via a network and improving access fairness are disclosed herein. In one embodiment, a device for communicating via a network includes a medium access controller (MAC). The MAC is configured to apply a contention window for collision avoidance on the network, and to determine whether the network is free for use on expiration of a time value of the contention window. The MAC is also configured to initiate a transmission based on a determination that the network is free for use. The MAC is further configured to increase, in accordance with a predetermined probability value, the time value of the contention window based on: the transmission being successful; and the time value of the contention window being a minimum contention window time value. The probability value establishes the likelihood of the MAC increasing the time value of the contention window with respect to successful transmissions with the minimum contention window time value.

In another embodiment, a method for accessing a shared communication medium includes setting, to a minimum contention window time value, a time value of a contention window used to determine whether the medium is free for use. A probability value that defines probability of increasing the time value of the contention window is set. Whether the medium is free for use on expiration of the minimum contention window time value is determined by a device that communicates via the medium. Responsive to the determining establishing that the medium is free for use, a transmission is initiated by the device. In accordance with the probability value, the time value of the contention window is increased by the device responsive to success of the transmission.

In a further embodiment, a communication network includes a plurality of devices configured to communicate via an interconnecting medium of the network. Each of the devices includes contention window management logic. The contention window management logic is configured to define a probability value that establishes the likelihood of increasing a time value of a contention window with respect to successful transmissions by the device with a minimum contention window time value. The time value of the contention window defines an interval monitored, by the device, for activity on the medium. The contention window management logic is configured to increase, in accordance with the probability value, the time value of the contention window based on successful completion of a transmission by the device, and the time value of the contention window being the minimum contention window time value at initiation of the transmission.

### BRIEF DESCRIPTION OF THE DRAWINGS

For a detailed description of exemplary embodiments of the invention, reference will now be made to the accompanying drawings in which:

FIG. 1 shows a block diagram of a network in accordance with various embodiments;

FIG. 2 shows a block diagram of a device including probabilistic contention window management for improving fairness of network access in accordance with various embodiments;

FIG. 3 shows a flow diagram for a method for probabilistic contention window management in accordance with various embodiments;

FIGS. 4A-4B show graphs of exemplary performance of networks implementing probabilistic contention window management;

FIG. 5 shows a flow diagram for a method for probabilistic contention window management with variable probability in accordance with various embodiments; and

FIGS. 6A-6B show graphs of exemplary performance of networks implementing probabilistic contention window management with variable probability in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software. The recitation “based on” is intended to mean “based at least in part on.” Therefore, if X is based on Y, X may be based on Y and any number of other factors.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various modifications to basic carrier sense multiple access with collision avoidance (CSMA/CA) have been implemented to improve one or more aspects of network operation. Additive decrease multiplicative increase (ADMI) is one such modification. ADMI attempts to adaptively modify the duration of the Contention Window (CW) based on the success or failure of medium access.

With ADMI, operation begins with a device setting its CW value to a minimum contention window time duration (CW=minCW). Next, the device generates a random number between 0 and CW, for example K, and attempts to access the medium after K*aUnitBackoffSlot duration time. aUnitBackoffSlot is a standard specified constant value. If the device finds the medium to be busy before or at expiration of K*aUnitBackoffSloti, then the device doubles CW, while limiting CW to a maximum duration (maxCW), and again contends for medium access (after waiting for the necessary inter frame space time). If the device gains access the medium, the device transmits a frame. If responsive to the transmission, the device receives acknowledgement (ACK) indicating the transmission was successful, the device decreases CW by A*minCW while limiting CW to no less than minCW. If no ACK is received, the value of CW is not changed.

Thus, ADMI doubles the value of CW on failure due to channel access/collision and reduces the value of CW by A*minCW on success as long as the resultant CW value is between minCW and maxCW, where the values minCW, maxCW and A are constants. Values for minCW, maxCW, and A may be, for example, 8, 256 and 8 respectively. Unfortunately, ADMI and similar schemes present fairness issues in some networks, for example, in saturated single-hop networks with a small number of devices.

Embodiments disclosed herein, provide equitable access to the communication medium in various types of networks. For example, embodiments provide fair access to the medium in single-hop networks with a small number of devices. Embodiments enhance network access fairness by providing that a device gaining access to the medium via a minimum contention window value may thereafter increase its contention window value in accordance with a predetermined probability value.

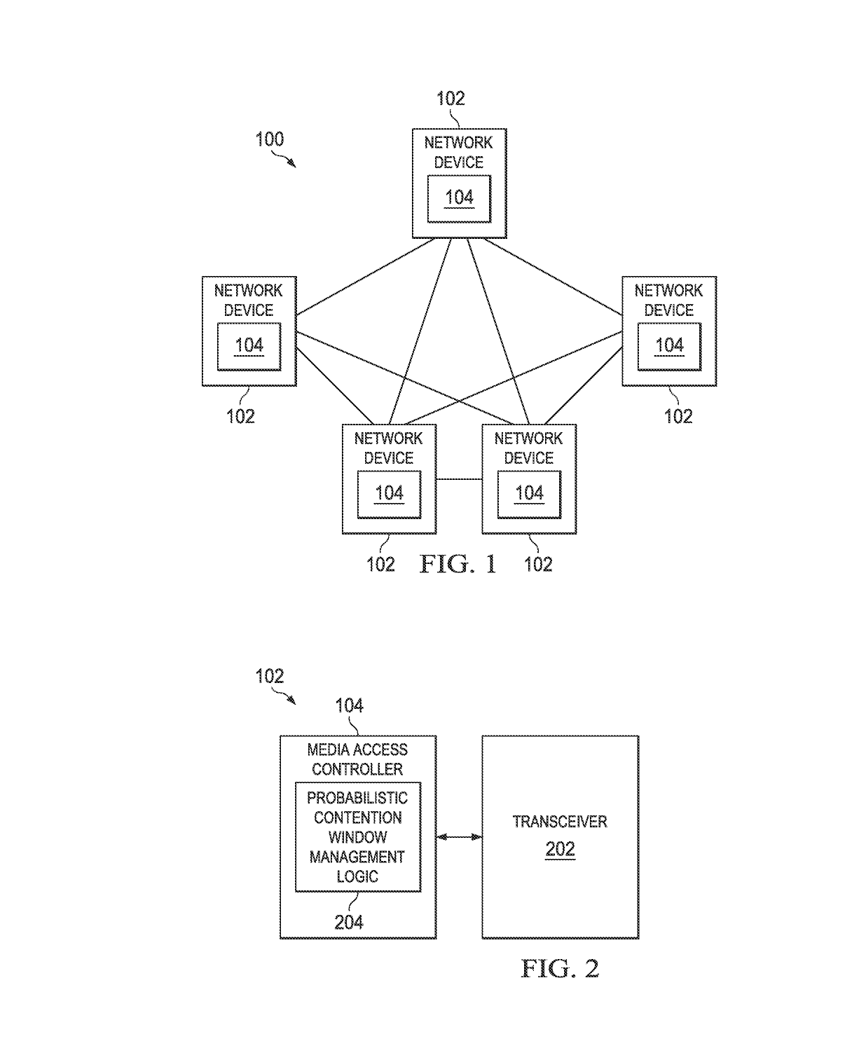

FIG. 1 shows block diagram of a network 100 in accordance with various embodiments. The network 100 includes a plurality of devices 102 that communicate via a network communication medium. In some embodiments of the network 100, the medium may include a wireless medium, and in other embodiments the medium may include a wired medium. In some embodiments, the medium includes electrical power conductors of an electrical power distribution system. In such an embodiment, the network 100 may be referred to as a power-line network.

The network devices 102 communicate via the communication medium of the network 100. A device 102 may be any of various devices configured to communicate via the network 100. For example, if the network 100 is a power line network, then a device 102 may be a residential or commercial power meter, or other power line network device. The network devices 102 may communicate directly with one another (single-hop) or communicate through one or more other of the network devices (multi-hop). In some configurations of the network 100, some devices 102 may be unable to communicate directly with others due, for example, to attenuation of the communication channel between the devices 102.

The network devices 102 share access to the communication medium through which data is transferred. Each network device 102 includes a medium access controller (MAC) 104 that manages access to the medium for the device 102 using CSMA/CA protocols. To improve the fairness of medium access, that is, to improve the likelihood that each device 102 has a fair opportunity to access the medium, the medium access controller 104 includes probabilistic contention window management logic. The probabilistic contention window management logic may, with predetermined probability, increase the length of the contention window applied by the device 102 when the device 102 successfully accesses the medium using a contention window of minimum duration. Thus, the probabilistic contention window management logic reduces the possibility of a device 102 monopolizing the medium, and increases the likelihood that other devices 102 gain access to the medium

FIG. 2 shows a block diagram of a device 102. The device 102 includes a MAC 104 and a transceiver 202. The transceiver 202 includes circuitry for accessing the medium of the network 100. For example, if the network 100 is a power line network, then the transceiver 202 includes circuitry for transmitting and receiving data via the power line network. The MAC 104 implements a multiple access protocol that allows the device 102 to share the communication medium of the network 100 with other instances of the device 102 and/or with other devices communicating via the network 100. The MAC 104 employs CSMA/CA as the multiple access protocol used to manage access to the medium of the network 100. The MAC 104 may also implement ADMI to adaptively modify the size of the contention window as described herein.

The MAC 104 includes probabilistic contention window management logic 204. The probabilistic contention window management logic 204 provides improved network access fairness relative to ADMI and other CSMA/CA protocols by applying a probability value that defines a probability that MAC 104 will increase the time value of CW when the device 102 successfully transmits after gaining access to the medium using a minimum contention window time value (CW=minCW).

In some embodiments of the probabilistic contention window management logic 204, after gaining access to the medium using a CW value of minCW, the logic 204 will choose with probability prob_return_to_high_CW to increase CW (e.g., increase CW to a predetermined high contention window time value), and choose with probability (1-prob_return_to_high_CW) to maintain CW at minCW. The increased CW time value is chosen to allow other devices 102 to contend in a fair manner for the medium of the network 100. Some embodiments may apply a value of maxCW or maxCW/2 (or any value between maxCW and maxCW/2) as the predetermined high contention window time value to which CW is increased. The probabilistic contention window management logic 204 applies the described CW increase process each time data is successfully transmitted using CW set to the minimum contention window value minCW.

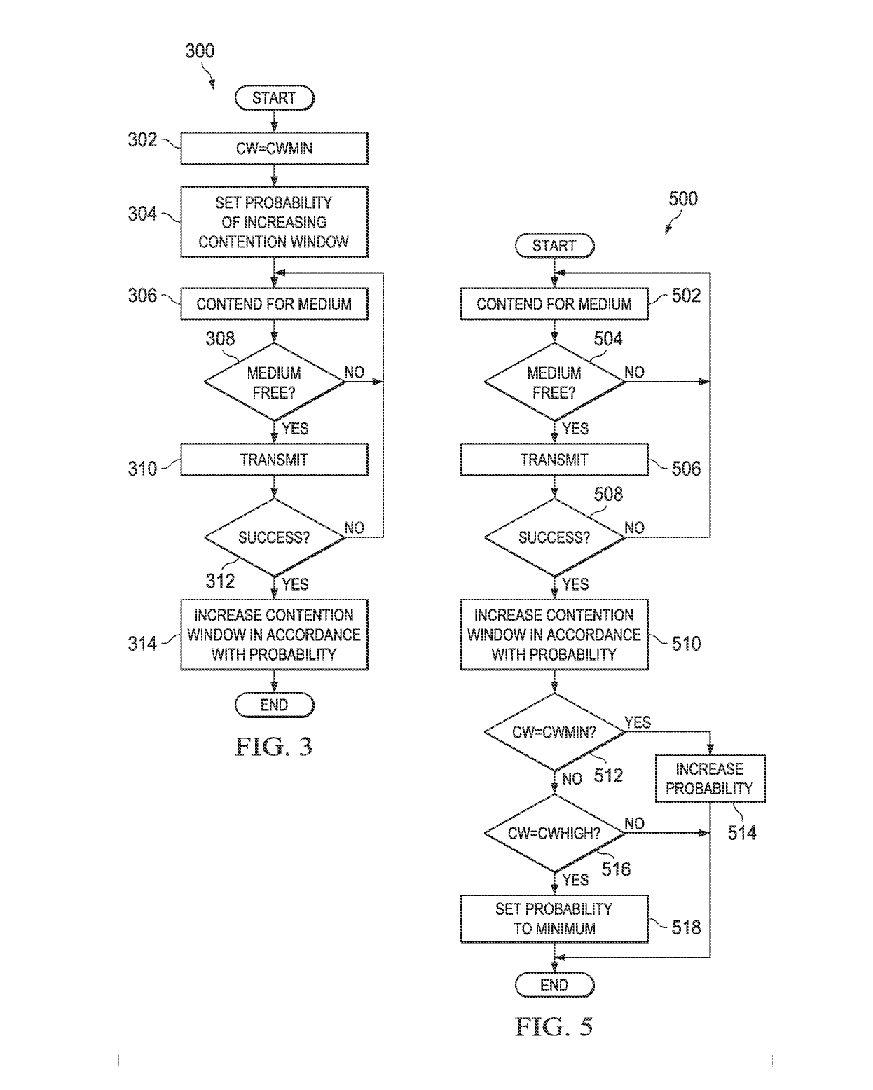

FIG. 3 shows a flow diagram for a method 300 for probabilistic contention window management in accordance with various embodiments. Though depicted sequentially as a matter of convenience, at least some of the actions shown can be performed in a different order and/or performed in parallel. Additionally, some embodiments may perform only some of the actions shown. At least some of the operations of the method 300 can be performed by the MAC 104 as part of the probabilistic contention window management logic 204 of the device 102.

In block 302, the device 102 is operating in the network 100. The MAC 104 sets the contention window used to contend for medium access to a predetermined minimum contention window time value.

In block 304, the device 102 sets a probability value that defines the probability of increasing the time value of the contention window if the device transmits successfully while using the minimum contention window time value. In some embodiments, the probability value may be set to a constant value between 0.1 and 0.15.

In block 306, the MAC 104 contends for access to the network medium. For example, the MAC 104 may monitor the medium for transmissions for the duration of the contention window to determine whether a different device is transmitting. If the medium is free from transmissions for the duration of the contention window, then the MAC 104 may determine that the device 102 can transmit.

In block 308, the MAC 104 determines whether the medium is free. For example, if the medium is free from transmissions for the duration of the contention window, then the MAC 104 may determine that the medium is free and the device 102 can transmit.

If the MAC 104 determines that the medium is free in block 308, then in block 310, the device 102 transmits. On the other hand, if in block 308 the MAC 104 determines that the medium is not free, then the MAC 104 continues to contend for access to the medium.

In block 312, the MAC 104 determines whether the transmission was successful. For example, the MAC 104 may determine that the transmission was successful based on reception of an acknowledgement transmission from a device receiving the transmission.

If the transmission is determined to be unsuccessful, then the MAC 104 contends for the medium to repeat the transmission. If the transmission is determined to be successful, then in block 314, the MAC 104 determines whether to increase the time value of the contention window. The MAC 104 increases the time value in accordance with the probability value set in block 304. The MAC 104 retains the minimum contention window value in accordance with probability (1-probability value). For example, the MAC 104 may generate a random value between 0 and 1. If the random value is between zero and the probability value, then the MAC 104 increases the time value of the contention window (e.g., to a predetermined high contention window time value). Otherwise, the MAC 104 does not change the contention window time value (i.e., the contention window retains the minimum time value). In some embodiments, the MAC 104 increases the contention window to a time value of at least half the maximum contention window time value.

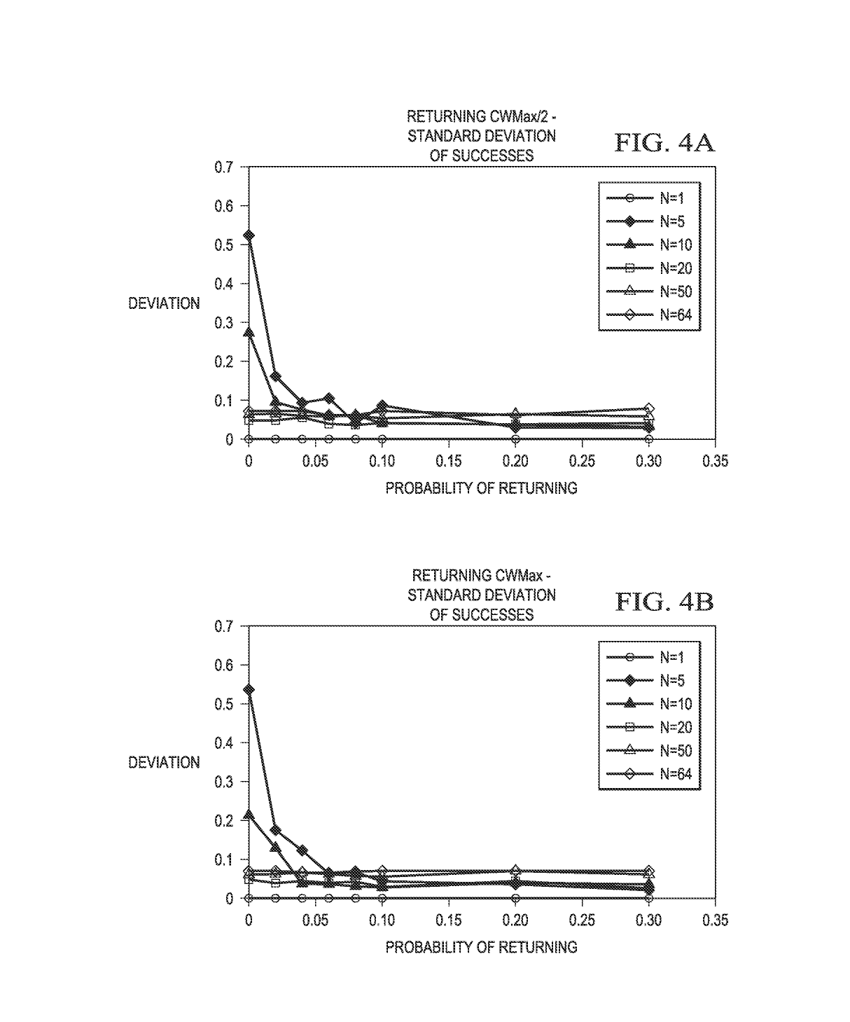

FIGS. 4A-4B show graphs of exemplary performance of networks implementing probabilistic contention window management in accordance with various embodiments. FIG. 4A shows standard deviation of successful medium access for various numbers (N) of devices 102 in a network 100. The standard deviation values are illustrated with respect to various probability values for increasing contention window time applied by the contention window management logic 204 in accordance with the method 300, wherein the contention window time value is increased from the minimum to half the maximum contention window value in accordance with the illustrated probability.

Similarly, FIG. 4B shows standard deviation of successful medium access for various numbers (N) of devices 102 in a network 100. The standard deviation values are illustrated with respect to various probability values for increasing contention window time applied by the contention window management logic 204 in accordance with method 300, wherein the contention window time value is increased to the maximum contention window value in accordance with the illustrated probability. As shown in FIGS. 4A-4B increasing the time value of the contention window in accordance with illustrated probability values substantially deceases the standard deviation of successful medium access (i.e., increases the fairness of medium access) in embodiments of the network 100.

Returning now to FIG. 2, some embodiments of the probabilistic contention window management logic 204 can vary the probability value prob_return_to_high_CW in response to network access conditions. Embodiments may increase the probability value with each successive successful access of the medium and transmission with CW set to the minimum CW time value. For example, if a given device 102 successful gains access to the medium and transmits on four successive attempts, each with CW=minCW, then the probabilistic contention window management logic 204 may increase the probability value with each successful attempt by a predetermined increase value (e.g., resulting in a probability value pattern of 0.1, 0.2, 0.3, 0.4). The range of probability values may be bounded by predetermined minimum and maximum probability values (e.g., 0.1 and 0.4 respectively in the illustrative pattern above). By increasing the probability value, embodiments allow other devices 102 to more quickly gain access to the medium.

In some embodiments of the probabilistic contention window management logic 204, if the contention window time value has been increased to a predetermined high contention window time value (e.g., maxCW or maxCW/2), and the device 102 gains access to the medium using the high contention window time value, the logic 102 may determine that very few devices 102 are contending for access to the network 100. Consequently, the logic 102 may set the probability value to a predetermined minimum probability value to be applied when a contention window of minimum duration is next applied to contend for access to the network 100.

FIG. 5 shows a flow diagram for a method for probabilistic contention window management with variable probability in accordance with various embodiments. Though depicted sequentially as a matter of convenience, at least some of the actions shown can be performed in a different order and/or performed in parallel. Additionally, some embodiments may perform only some of the actions shown. At least some of the operations of the method 500 can be performed by the MAC 104 as part of the probabilistic contention window management logic 204 of the device 102.

In block 502, the device 102 is operating in the network 100. The MAC 104 has set the contention window to a time value, and set the probability value that defines the probability of increasing the time value of the contention window if the device 102 transmits successfully while using a minimum contention window time value. The MAC 104 contends for access to the network medium. For example, the MAC 104 may monitor the medium for transmissions for the duration of the contention window to determine whether a different device is transmitting. If the medium is free from transmissions for the duration of the contention window, then the MAC 104 may determine that the device 102 can transmit.

In block 504, the MAC 104 determines whether the medium is free. For example, if the medium is free from transmissions for the duration of the contention window, then the MAC 104 may determine that the medium is free and the device 102 can transmit.

If the MAC 104 determines that the medium is free in block 504, then in block 506, the device 102 transmits. On the other hand, if in block 504 the MAC 104 determines that the medium is not free, then the MAC 104 continues to contend for access to the medium.

In block 508, the MAC 104 determines whether the transmission was successful. For example, the MAC 104 may determine that the transmission was successful based on reception of an acknowledgement transmission from a device 102 receiving the transmission initiated in block 506.

If the transmission is determined to be unsuccessful, then the MAC 104 contends for the medium to repeat the transmission. If the transmission is determined to be successful, then in block 510, the MAC 104 determines whether to increase the time value of the contention window. The MAC 104 increases the time value in accordance with the probability value. The MAC 104 retains the minimum contention window value in accordance with probability (1-probability value). For example, the MAC 104 may generate a random value between 0 and 1. If the random value is between zero and the probability value, then the MAC 104 increases the time value of the contention window to a predetermined high contention window time value. Otherwise, the MAC 104 does not change the contention window time value (i.e., the contention window retains the minimum time value). In some embodiments, the MAC 104 increases the contention window to a time value of at least half the maximum contention window time value.

In block 512, the MAC 104 determines whether the contention window is set to the minimum contention window time value. If the contention window is set to the minimum time value, then in block 514, the MAC 104 increases the probability value. For example, the MAC 104 may increase the probability value by a predetermined probability increment value as long as the incremented probability value is within predetermined range of probability values.

If, in block 512, MAC 104 determines that the contention window is not set to the minimum value, then in block 516, the MAC 104 determines whether the contention window is set to a predetermined high contention window time value. If the contention window is set to the high contention window time value, responsive to a probability value based increase in contention window time value, then in block 518, the MAC 104 sets the probability value to a predetermined minimum probability value.

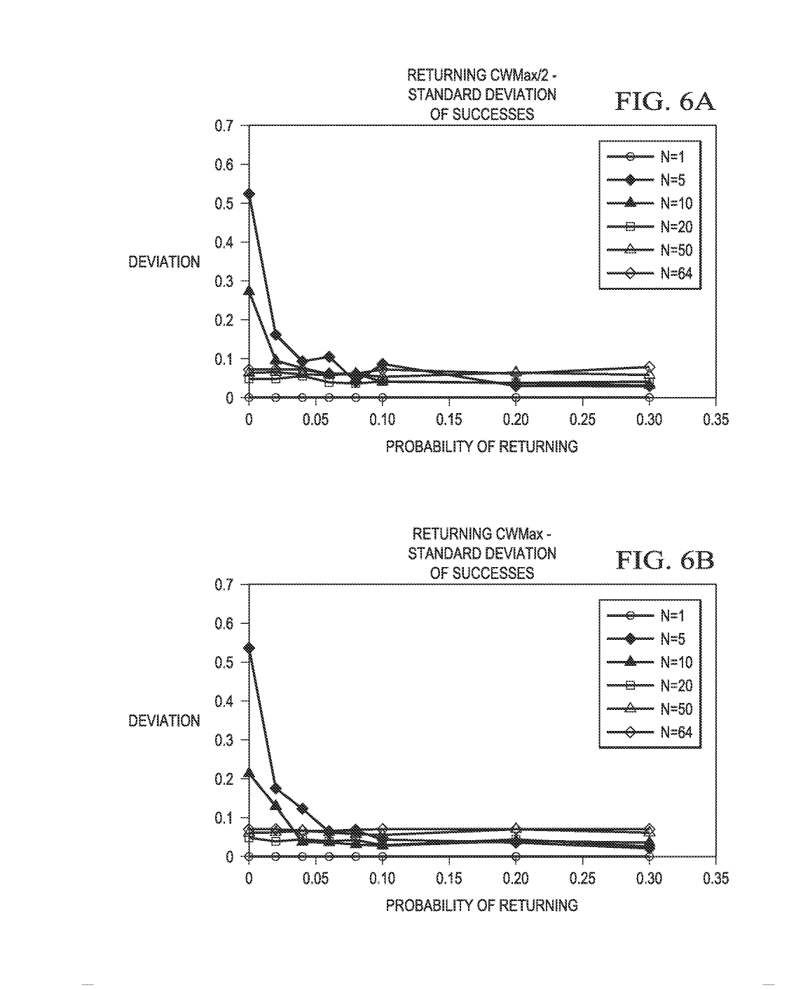

FIGS. 6A-6B show graphs of exemplary performance of networks implementing probabilistic contention window management with variable probability in accordance with various embodiments. FIG. 6A shows standard deviation of successful medium access for various numbers (N) of devices 102 in a network 100. The standard deviation values are illustrated with respect to various probability values for increasing contention window time applied by the contention window management logic 204 in accordance with method 500, wherein the contention window time value is increased to half the maximum contention window value in accordance with the illustrated probability.

Similarly, FIG. 6B shows standard deviation of successful medium access for various numbers (N) of devices 102 in a network 100. The standard deviation values are illustrated with respect to various probability values for increasing contention window time applied by the contention window management logic 204 in accordance with method 500, wherein the contention window time value is increased to the maximum contention window value in accordance with the illustrated probability. As shown in FIGS. 6A-6B increasing the time value of the contention window and varying the probability value as described herein substantially deceases the standard deviation of successful medium access (i.e., increases the fairness of medium access) in embodiments of the network 100.

In some embodiments of the device 102, at least some functionality of the MAC 104, including portions of the probabilistic contention window management logic 204 may be implemented by a processor executing software instructions retrieved from a non-transitory computer-readable storage device, such as semiconductor memory. Some embodiments of the MAC 104 and the probabilistic contention window management logic 204 may be implemented using dedicated hardware circuitry and/or a processor executing software instructions. Similarly, operations of the methods 300 and/or 500 may be performed by the device 102 via a processor executing instructions stored in a computer readable storage device.

Suitable processors include, for example, general-purpose microprocessors, digital signal processors, and microcontrollers. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. Software programming (i.e., processor executable instructions) that causes a processor to perform the operations disclosed herein can be stored in a computer readable storage device. A computer readable storage device comprises volatile storage such as random access memory, non-volatile storage (e.g., a hard drive, an optical storage device (e.g., CD or DVD), FLASH storage, read-only-memory), or combinations thereof.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method for accessing a shared communication medium, comprising:
setting, to a minimum contention window time value, a time value of a contention window used to determine whether the medium is free for use;
setting a probability value defining probability of increasing the time value of the contention window;
determining, by a device that communicates via the medium, whether the medium is free for use on expiration of the minimum contention window time value;
transmitting, by the device, responsive to the determining establishing the medium is free for use;
increasing, by the device, the time value of the contention window responsive to success of the transmitting in accordance with the probability value.

2. The method of claim 1, wherein the probability value is a constant.

3. The method of claim 1, further comprising:
defining a maximum contention window time value;
wherein the increasing sets the time value of the contention window to a value in a range of half the maximum contention window time value to the maximum contention window time value.

4. The method of claim 1, further comprising increasing the probability value based on successfully gaining access to the medium on successive access attempts with the time value of the contention window set to the minimum contention window time value.

5. The method of claim 4, further comprising decreasing the probability value based on successfully gaining access to the medium with the value of the contention window set to a predetermined high contention window time value.

6. The method of claim 5, wherein decreasing the probability value comprises setting the probability value to a predetermined minimum value.

7. A device for communicating via a network, comprising:
a medium access controller (MAC) configured to:
apply a contention window for collision avoidance on the network;
determine whether the network is free for use on expiration of a time value of the contention window;
initiate a transmission based on a determination that the network is free for use;
increase, in accordance with a predetermined probability value, the time value of the contention window based on:
the transmission being successful; and
the time value of the contention window being a minimum contention window time value;
wherein the probability value establishes the likelihood of the MAC increasing the time value of the contention window with respect to successful transmissions with the minimum contention window time value.

8. The device of claim 7, wherein the probability value is set to a constant.

9. The device of claim 7, wherein the MAC is configured to increase, in a single step, the time value of the contention window from the minimum contention window time value to at least half of a maximum contention window time.

10. The device of claim 7, wherein the MAC is configured to increase the probability value based on a determination that the network is free for use on successive access attempts with the time value of the contention window being the minimum contention window time value.

11. The device of claim 7, wherein the MAC is configured to decrease the probability value based on a determination that the network is free for use with the time value of the contention window set to a predetermined high contention window time value.

12. The device of claim 11, wherein the MAC is configured to decrease, in a single step, the probability value to a minimum predetermined probability value.

13. The device of claim 7, further comprising a transceiver configured to access a power line network.

14. A communication network, comprising:
a plurality of devices configured to communicate via an interconnecting medium of the network, each of the devices comprising contention window management logic configured to:
define a probability value that establishes the likelihood of increasing a time value of a contention window with respect to successful transmissions by the device with a minimum contention window time value; wherein the time value of the contention window defines an interval monitored, by the device, for activity on the medium; and
increase, in accordance with the probability value, the time value of the contention window based on:
successful completion of a transmission by the device; and
the time value of the contention window being the minimum contention window time value at initiation of the transmission.

15. The network of claim 14, wherein the contention window management logic is configured to set the probability value to a constant.

16. The network of claim 14, wherein the contention window management logic is configured to increase, in a single step, the time value of the contention window from the minimum contention window time value to at least half of a maximum contention window time value.

17. The network of claim 14, wherein the contention window management logic is configured to increase the probability value based on a determination that the network is free from activity on successive access attempts to access the network with the time value of the contention window being the minimum contention window time value.

18. The network of claim 14, wherein the contention window management logic is configured to decrease the probability value based on a determination that the network is free from activity with the time value of the contention window set to a predetermined high contention window time value.

19. The network of claim 18, wherein the contention window management logic is configured to decrease, in a single step, the probability value to a predetermined minimum contention window time value.

20. The network of claim 14, wherein the interconnecting medium comprises an electricity distribution network.
